(19) United States
(12) Patent Application Publication
(10) Pub. No.: US 2010/0239113 A1
(43) Pub. Date: Sep. 23, 2010

(54) Microphone mount

(76) Inventor: David Browne, County Dublin (IE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/582,719

(22) PCT Filed: Dec. 13, 2004
(86) PCT No.: PCT/EP04/14374

§ 371 Date: Apr. 26, 2007

(30) Foreign Application Priority Data
Dec. 12, 2003 (IE) S2003/0938

(51) Int. Cl. H04R 9/04

(52) U.S. Cl. 381/361

(57) ABSTRACT

A mount for a microphone 34 clamps the microphone body 36 at a plurality of discrete points on the circumference of the body. The microphone body is clamped between two sets of three threaded bolts 18, each set of bolts extending radially inwardly from a respective surrounding annular support 14. Each bolt is radially adjustable by rotation in its support to accommodate microphone bodies of different diameters.

The present invention relates to a mount for a microphone.

Conventionally microphone mounts or stands are divided into two distinct categories, and although the designs of particular mounts within both categories varies widely, the underlying function does not change. The first category, and the most common type of mount, is the collar or sleeve type mount, in which the microphone is held rigidly within a sleeve or collar connected directly to a boom or similar stand. The internal surface of the collar corresponds roughly in shape and dimension to the body portion of the microphone, such as to form a snug fit therewith. This type of mount is predominantly formed with a split sleeve having a slight taper, in order to effect a taper lock with the microphone, the split sleeve allowing the mount to be used with microphones of slightly different size. The sleeve type mount is generally considered to provide reasonable sound quality, but with certain applications, does not adequately isolate the microphone from external vibrations, and is therefore confined to use in applications requiring low to medium sound quality.

For applications such as studio use or the like, it is vital to reduce to a minimum the structural and/or ground borne external vibrations transmitted to the microphone, which external vibrations are concentrated in the ultra low infrasonic frequency range. Such vibrations may result from, for example, traffic, heavy machinery, seismic energy, or indeed electrical equipment present in the studio or site in question. Thus the second category of microphone mount, which is intended to isolate a microphone mounted therein from such vibrations, is commonly known as a shock mount. Shock mounts come in many different forms, but will usually comprise some form of outer frame, and a floating inner collar or grommet into which the microphone sits, the collar being secured to the outer frame by a number of elastic cords or bands. Thus the cords act as a damping medium between the outer frame, which in use is secured to a boom or the like, and the inner collar, in which the microphone is held. While a shock mount substantially reduces the disturbance to the microphone from external vibrations, it has been found that for most studio type applications, such mounts do not sufficiently reduce the transmission of the above mentioned infrasonic vibrations.

It is therefore an object of the present invention to provide an improved microphone mount which reduces or eliminates the transmission of infrasonic vibrations to a microphone held within the mount.

According to a first aspect of the present invention, there is provided a mount for a microphone, the mount being adapted to clamp a microphone body at a plurality of discrete points on the circumference of the body.

Preferably, the plurality of discrete points comprises at least one set of at least three discrete points disposed around the circumference of the microphone body.

Preferably, the mount is adapted to clamp the microphone body at first and second sets of at least three discrete points around its circumference, the first and second sets of discrete points lying in substantially parallel spaced planes.

Preferably, in the or each set, the discrete points are substantially equally spaced around the circumference of the microphone body.

Preferably, the mount comprises a frame and a plurality of members extending inwardly from the frame to engage the microphone body at the or each set of discrete points.

Preferably, in the or each set the discrete points are engaged by the free ends of respective members extending inwardly from a respective support surrounding the microphone body.

Preferably, the free end of each member comprises a foot mounted to the respective member by a universal joint.

Preferably, the or each surrounding support comprises an annular ring and the inwardly extending members extend at least generally radially thereof.

Preferably, there are two supports connected together by a rigid cross member.

Preferably, at least one inwardly extending member is adjustable to allow the mount to accommodate microphone bodies of different diameters.

Preferably, the at least one inwardly extending member comprises a bolt which is threaded through the respective support.

According to a second aspect of the present invention, there is provided a method of clamping a microphone in a mount such as to reduce the transmission of vibrations thereto through the mount, the method comprising clamping the microphone at a plurality of discrete points on the circumference of the microphone body.

In an embodiment of the invention he microphone body is clamped between two sets of three threaded bolts, each set of bolts extending radially inwardly from a respective surrounding annular support. Each bolt is radially adjustable by rotation in its support to accommodate microphone bodies of different diameters.

It will be understood that the term “point” is not intended to be interpreted herein with mathematical precision, but rather refers to a limited area of the microphone body which is small compared to its overall surface area.

Embodiments of the present invention will now be described, by way of example, with reference to the accompanying drawings, in which:

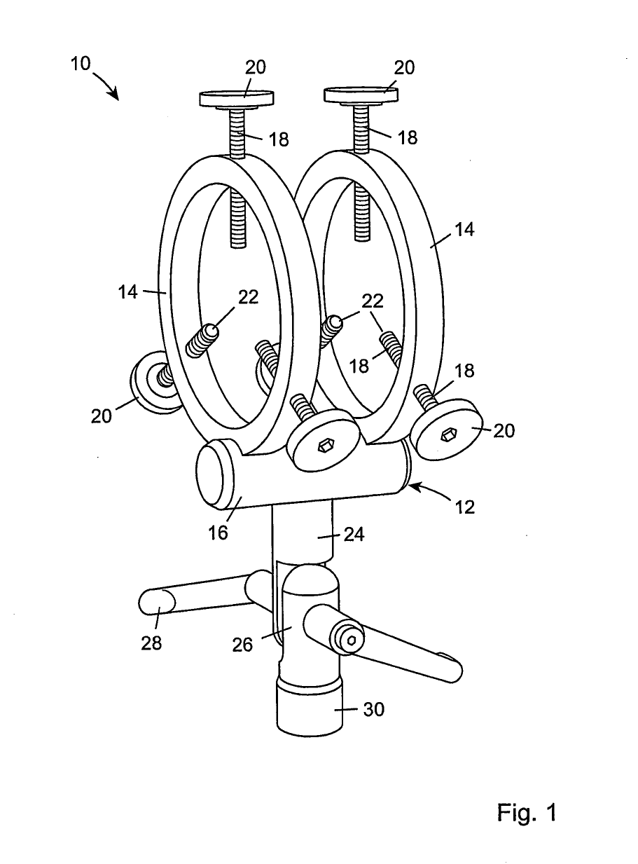

FIG. 1 is a perspective view of a first embodiment of a mount for a microphone according to the present invention;

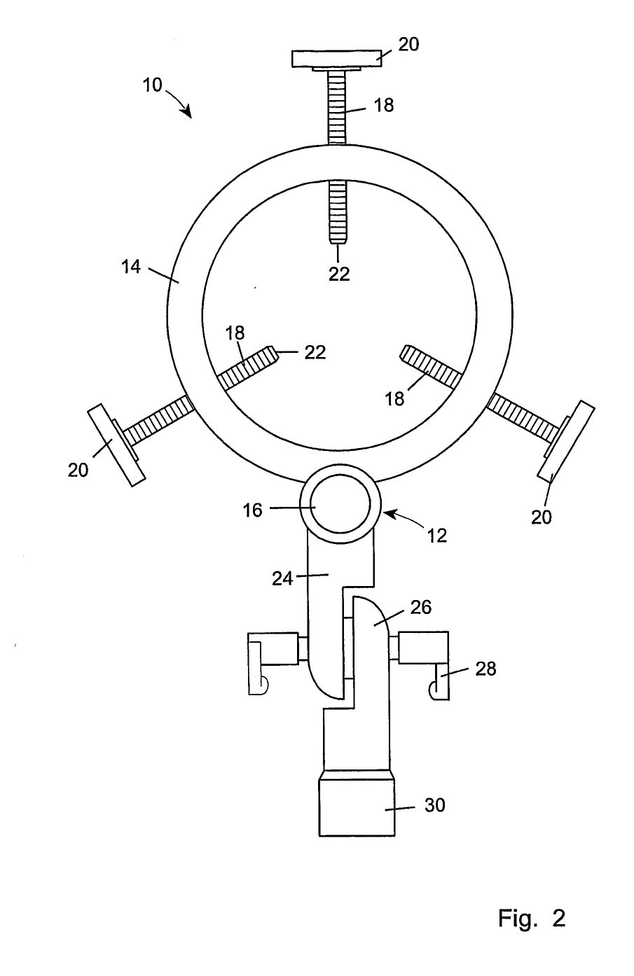

FIG. 2 is a front elevation of the mount of FIG. 1;

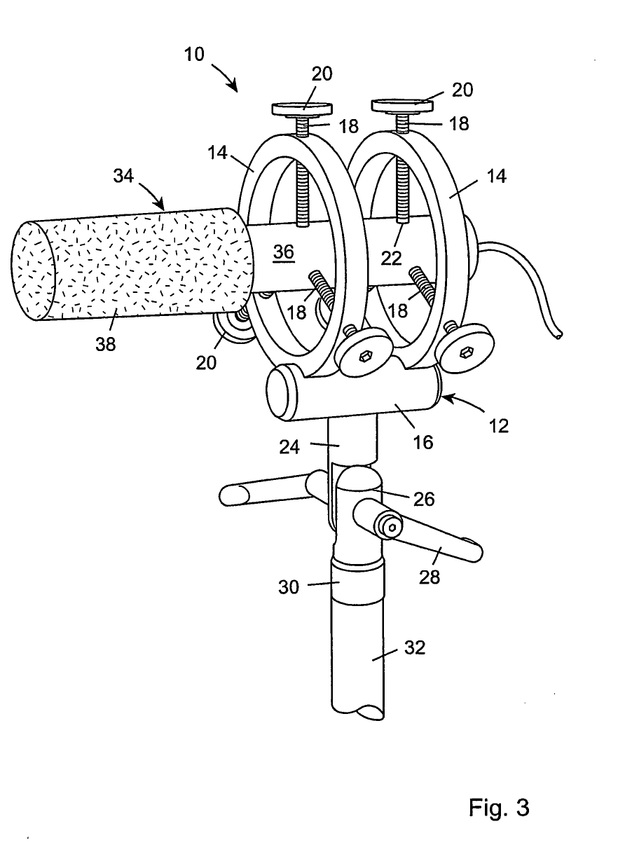

FIG. 3 is a perspective view of the mount of FIG. 1 in which a microphone is clamped; and

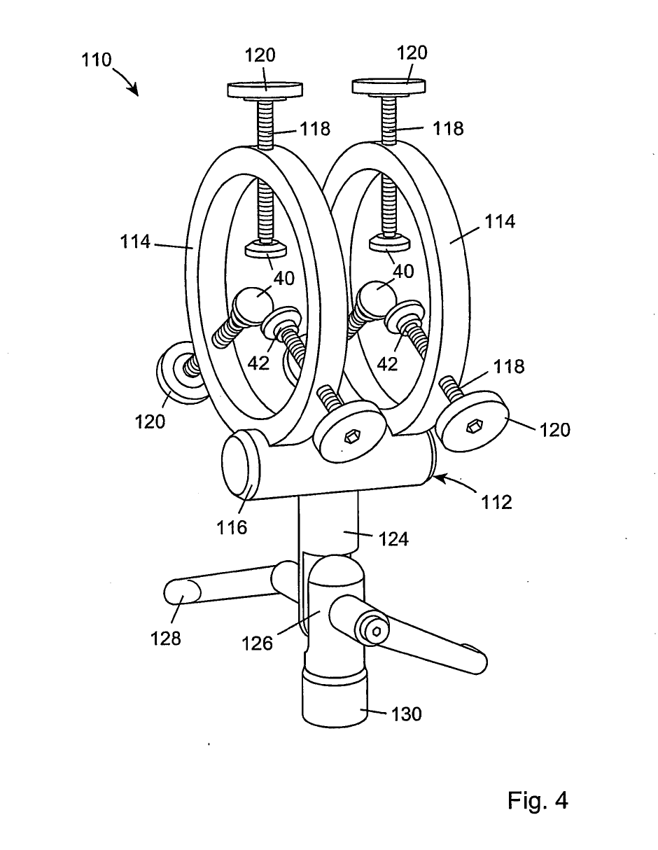

FIG. 4 is a perspective view of a second embodiment of a mount for a microphone according to the present invention.

Referring now to FIGS. 1 to 3 of the accompanying drawings, there is illustrated a mount, generally indicated as 10, for clamping a microphone 34 such as to substantially reduce or eliminate the transmission of infrasonic vibrations to the microphone 34. The mount 10 comprises a rigid frame 12 in which to secure the microphone 34, which microphone 34 comprises a body 36 and a head 38. The frame 12 is preferably mountable, in use, to a conventional microphone stand or boom 32, and in the illustrated embodiment, by an internally threaded collar 30.

For practical purposes, the frame 12 is connected via a neck 24 to an elbow joint 26, which is operable in conventional fashion by a pair of levers 28. The elbow joint includes a washer, preferably of plastics material, disposed between the two sides thereof in order to reduce friction. Thus, the inclination of the frame 12 relative to the boom 32 may be varied to suit particular applications.

The frame 12 comprises a pair of supports in the form of coaxial annular rings 14 disposed in parallel spaced relation to one another and secured together by a cross member 16. It will however be appreciated from the following description of the invention that the frame 12 can vary widely in size and/or shape, provided the desired functionality is achieved, as will be described in detail hereinafter. In the present embodiment the entire frame 12 is formed from a rigid material such as a metal, for example stainless steel or aluminium.

Each annular ring 14 carries three rigid members in the form of respective bolts 18, each of which is threaded through the respective annular ring 14 and extends inwardly towards the centre of the ring 14 at least in a generally radial direction. Thus the free inner end of each bolt 18 can be advanced towards, or drawn away from, the centre of the respective annular ring 14 by rotation of the bolt relative to the ring 14, such rotation being facilitated by a dial 20 at the outer end of each bolt 18. Thus in order to secure the microphone 34 within the mount 10, each bolt 18 is rotated for movement outwardly of the ring 14 a distance sufficient to allow the body 36 of the microphone 34 to be passed through, and be surrounded by, the pair of annular rings 14. Then, each bolt 18 is rotated for movement towards the microphone body 36, such that the free end 22 of each bolt 18 engages a discrete point on the circumference of the body 36, thereby clamping the microphone 34 within the mount 10.

The bolts 18 are preferably equiangularly spaced around their respective rings 14, such that for each ring 14 the microphone body 36 is clamped at substantially equally spaced points around its circumference.

It has surprisingly been found that clamping the microphone 34 in this way results in a substantial reduction in the transmittal of infrasonic vibrations to the microphone 34 from structural and/or ground borne sources. Following this surprising discovery, it has been found, through experimentation, that by clamping the microphone 34 at only two discrete points a reduction in the transmittal of vibrations to the microphone 34 is experienced, although it will be appreciated that such a configuration is relatively unstable since the microphone 34 is easily disturbed or dislodged.

Similarly, the application of clamping pressure to three discrete points around the circumference of the microphone 34 again produces a substantial reduction in the transmittal of vibrations thereto, but is again relatively unstable for practical purposes, and has a tendency to become disturbed or dislodged, in particular if an attempt is made to move the microphone 34.

Thus, in practice, it has been found that the one of the most practical and preferred arrangements is that of the mount 10 illustrated in FIGS. 1 to 3, which applies point pressure at a first set of three discrete points lying substantially in a first plane, and a second set of three discrete points lying substantially in a second plane in parallel spaced relation to the first plane. Thus it will be understood that the essence of the invention is in clamping the microphone 34 by the application of clamping pressure at discrete points, and is therefore not intended to be limited to the particular embodiment illustrated, in which pressure is applied to the microphone 34 at six points.

Referring now to FIG. 4 of the accompanying drawings, there is illustrated an alternative embodiment of a mount according to the present invention, generally indicated as 110, again for holding a microphone (not shown in FIG. 4) such as to substantially reduce or eliminate the transmission of infrasonic vibrations thereto. In this alternative embodiment, like components have been accorded like reference numerals, and unless otherwise stated, perform a like function.

The single difference between the mount 110 and the mount 10 is the provision of a foot 40 at the free end of each of a plurality of bolts 118. These feet 40 prevent damage to the casing of any microphone clamped within the mount 110. In order to enable each foot 40 to closely follow the contour of the microphone, so as to effectively grip same, each foot 40 is preferably mounted to the respective bolt 118 by means of a universal ball and socket joint 42. It will of course be appreciated that any other suitable form of foot 40 could be used, and need not be provided with the ball and socket joint 42.

It will consequently be appreciated that the frame 12;112 could be reconfigured to any other suitable shape which permits the six bolts 18;118 to be carried in the particular orientation illustrated. It will furthermore be appreciated that the threaded bolts 18;118 could be replaced by any other suitable equivalent which is capable of applying a point load to the body 36 of the microphone 34 (not shown in FIG. 4). For example, a spring loaded rod or cam arrangement (not shown) could be substituted for each of the bolts 18;118.

It will be appreciated that the operation of the mount 10;110 is in direct opposition to the teachings of prior art shock mounts, from which it is clear that some form of elastic or resiliently deformable coupling must be provided between the microphone 34 and associated stand in order to dampen any vibrations. However, the mount 10;110 of the present embodiments rigidly clamps the microphone 34 by means of the frame 12;112 and plurality of bolts 18;118. Despite this rigid coupling, the mount 10;110 has been found to significantly reduce, or eliminate, the transmission of infrasonic vibrations from external sources to the microphone 34.

1. A mount for a microphone, the mount being adapted to rigidly clamp a microphone body at a plurality of discrete points on the circumference of the body.

2. A microphone mount as claimed in claim 1, wherein the plurality of discrete points comprises at least one set of at least three discrete points disposed around the circumference of the microphone body.

3. A microphone mount as claimed in claim 2, wherein the mount is adapted to clamp the microphone body at first and second sets of at least three discrete points around its circumference, the first and second sets of discrete points lying in substantially parallel spaced planes.

4. A microphone mount as claimed in claim 2, wherein in the or each set the discrete points are substantially equally spaced around the circumference of the microphone body.

5. A microphone mount as claimed in claim 2, wherein the mount comprises a frame and a plurality of members extending inwardly from the frame to engage the microphone body at the or each set of discrete points.

6. A microphone mount as claimed in claim 5, wherein in the or each set the discrete points are engaged by the free ends of respective members extending inwardly from a respective support surrounding the microphone body.

7. A microphone mount as claimed in claim 6, wherein the free end of each member comprises a foot mounted to the respective member by a universal joint.

8. A microphone mount as claimed in claim 6, wherein the or each surrounding support comprises an annular ring and the inwardly extending members extend at least generally radially thereof.

9. A microphone mount as claimed in claim 6, wherein there are two supports connected together by a rigid cross member.

10. A microphone mount as claimed in claim 5, wherein at least one inwardly extending member is adjustable to allow the mount to accommodate microphone bodies of different diameters.

11. A microphone mount as claimed in claim 9, wherein the at least one inwardly extending member comprises a bolt which is threaded through the respective support.

12. A method of clamping a microphone in a mount such as to reduce the transmission of vibrations thereto through the mount, the method comprising clamping the microphone at a plurality of discrete points on the circumference of the microphone body.
